(19) United States
(12) Patent Application Publication
(10) Pub. No.: US 2006/0120566 A1
(43) Pub. Date: Jun. 8, 2006

(54) Optical inspection device

(76) Inventors: Toru Myogadani, Kanagawa (JP); Masayoshi Tatsu, Kanagawa (JP)

Correspondence Address: GREENBLUM & BERNSTEIN, P.L.C., 1950 ROLAND CLARKE PLACE, RESTON, VA, 20191, US

(21) Appl. No.: 10/553,947

(22) PCT Filed: Apr. 23, 2004
(86) PCT No.: PCT/JP04/05952

§ 371 Date: Jan. 4, 2006

(30) Foreign Application Priority Data
Apr. 24, 2003 (JP) 2003-120649

(51) Int. Cl. G06K 9/00

(52) U.S. Cl. 382/109; 382/110

(57) ABSTRACT

In the optical inspection apparatus according to the invention, in a case where an optical change such as white turbidity and white sedimentation, or fluorescence is caused to a sample accompanying the reaction of amplifying an object to be inspected present in a sample tube, sample tubes are stood and arranged in a plurality of arrangement holes formed in a reaction block, an inspection light is irradiated to the respective sample tubes passing through the observation holes formed to the lateral surface or the holes formed in the bottom and optical change such as white turbidity and white sedimentation or fluorescence caused in the sample tube are detected based on the luminance distribution or the chromaticity distribution of image data photographed by the image pick-up camera thereby enabling accurate and rapid inspection for the presence or absence of an object to be inspected.

### TECHNICAL FIELD

The present invention concerns an optical inspection apparatus for inspecting the presence or absence of an object to be inspected that causes optical change such as white turbidity and white sedimentation, or fluorescence for a sample charged in a sample tube.

### BACKGROUND ART

In the fields of biochemistry, medicine and pharmacy, foodstuffs, etc., simple, rapid, accurate and inexpensive gene amplification methods have been demanded and an LAMP method has been noted in recent years as a novel gene amplification method capable of satisfying such a demand.

The LAMP method not only shows an extremely high amplification efficiency but also forms a great amount of magnesium pyrophosphate as a byproduct formed by coupling of pyrophosphate ions liberated from a substrate (dNTPs) and magnesium ions in a reaction solution upon elongation synthesis of genes (DNA) in a sample tube, and white turbidity and white sedimentation are observed in the sample tube.

On the other hand, in a case where a sample per se is turbid, white turbidity and white sedimentation can not be observed and, by previously injecting a phosphorescent material that interacts with a gene to be amplified to emit fluorescence, fluorescence is observed in the sample tube by irradiation of an excitation light to the sample.

Accordingly, it can be distinguished simply whether the gene amplification has been conducted or not, that is, whether a predetermined gene to be inspected (object to be inspected) has been present or not by observing the white turbidity and white sedimentation, or fluorescence.

FIG. 8 is an explanatory view showing a main portion of an inspection apparatus that detects the degree of white turbidity and white sedimentation of a sample by the presence or absence of amplification in the LAMP method on real time along with progress of reaction.

In an optical inspection apparatus 31, observation holes 35—are perforated respectively to a plurality of arrangement holes 34—used for standing sample tubes 33 formed in a reaction block 32 each in perpendicular to the arrangement hole 34, and a light emitting device 36 for irradiating an inspection light to the sample tube 33 and a photoreceiving device 37 for detecting an inspection light that transmits the sample tube 33 are disposed along the optical axis that transmits each of the observation holes 35.

With this constitution, in a case where samples are charged in the sample tubes 33 respectively and arranged in the reaction block 32 and when reaction is conducted under a predetermined temperature condition while detecting a light irradiated from the light emitting device 36 and transmitting the sample tube 33 by the photoreceiving device 37, since white turbidity and white sedimentation are caused to lower the intensity of the transmission light for the sample in which the gene amplification precedes, presence or absence of the white turbidity and white sedimentation can be detected based on the change of the amount of light and it can be judged that an object to be inspected is present in a case where white turbidity and white sedimentation occur.

However, it may be considered that the intensity of light detected by the photoreceiving device 37 is changed not only by white turbidity and white sedimentation of the sample but also due to the change of optical characteristics of the light emitting device 36 and the photoreceiving device 37.

That is, in a case where the amount of light from the light emitting device 36 lowers or the output characteristic of the photoreceiving device 37 changes during the reaction, it may be possibly judged erroneously that the amplification is insufficient irrespective of the occurrence of white turbidity and white sedimentation of the sample or judged erroneously that the amplification has been completed irrespective of the absence of the white turbidity and white sedimentation.

Particularly, since the reaction block 32 is heated, there is a high possibility that the optical characteristics of the light emitting device 36 and the photoreceiving device 37 are changed under the effect of the temperature.

Accordingly, an LED with a light amount monitor has been used so far as the light emitting device 36 to maintain the amount of irradiation light constant, as well as the light emitting device 36 and the photoreceiving device 37 are situated being spaced apart from the reaction block 32 in order to exclude the effect of heat of the reaction block 32, thereby minimizing the thermal change of the optical characteristics.

However, in a case of situating the light emitting device 36 and the photoreceiving device 37 being spaced apart from the reaction block 32 in which the arrangement holes 34 are formed about by the number of 8, since alignment of optical axes is necessary for optical devices each by the number of 8 for the light emitting device 36 and the photoreceiving device 37 by the number as much as 16 in total, this results in a problem that the alignment of optical axes is extremely troublesome in the stage of assembling the apparatus.

Further, while the effect of heat given to each of the light emitting devices 36 and the photoreceiving device 37 decreases as each of the devices 36 and 37 are spaced more from the reaction block 32, since they tend to suffer from the effect of external light, this also gives a trouble that a dark room for housing the reaction block 32 is installed has to be formed.

Further, since the turbidity is measured only based on the intensity of the transmission light by the photoreceiving device 37, in a case where other external factors, for example, clouding and bubbling occur in the sample tube 33, measurement becomes inaccurate.

In addition, since they are often caused during reaction, they may occur even when the optical characteristics of the each device 36, 37 are stable, or the reaction block 32 is placed in the dark room.

Each of the problems described also occurs in a case where the presence or absence is intended to be inspected by fluorescence for an object to be inspected.

In view of the above, a technical subject of the present invention is to enable detection for the presence or absence of white turbidity and white sedimentation formed accompanying the reaction of the sample irrespective of the change of the amount of the inspection light and clouding and bubbling in the sample tube, and enable for saving of accurate alignment of optical axes for each of optical devices thereby also simplifying the assembling operation.

### DISCLOSURE OF THE INVENTION

The present invention provides an optical inspection apparatus for inspecting the presence or absence of an object to be inspected that causes optical changes such as white turbidity and white sedimentation, or fluorescence for a sample charged in a sample tube, including a reaction block in which a plurality of arrangement holes for standing and arranging sample tubes are formed, a light emitting portion for irradiating an inspection light to the respective sample tubes through observation holes formed to the lateral surface or holes formed in the bottom of the reaction block, an image pick-up camera for photographing each of the sample tubes passing through the observation holes, and an operation processing device for measuring the optical change caused in the sample tubes based on the luminance distribution or the chromaticity distribution of image data photographed by the image pick-up camera.

According to the optical inspection apparatus of the invention by irradiating an inspection light to a sample tube, optical changes caused in each of the samples by white turbidity and white sedimentation, or fluorescence can be photographed simultaneously by the camera.

For example, in a case where the presence or absence of the gene amplification due to the LAMP method is intended to be judged by using a transparent sample based on the turbidity of the sample, in a state where the gene amplification does not yet proceed and the sample remains transparent, since the light irradiated from below does not scatter in the sample tube, the light scarcely leaks through the observation hole and, accordingly, it appears dark when photographed by the image pick-up camera.

Further, as the gene amplification proceeds and the sample causes white turbidity and white sedimentation, since the light irradiated form below scatters in the sample tube, the scattered light leaks through the observation hole and, accordingly, it appears bright when photographed by the image pick-up camera.

In this case, since all of the sample tubes can be photographed simultaneously by the image pick-up camera, presence or absence of white turbidity can be detected in each of areas by specifying the areas in the images corresponding to the positions for the observation holes and it can be judged easily which sample causes white turbidity.

Further, the data for the luminance distribution or the chromaticity distribution read from the image data of each of the sample tubes photographed by the image pick-up camera are recognized not merely as numerical values but as three dimensional information with the position of the turbid portion on the images being at the XY coordinate and the luminance being at the Z coordinate.

Accordingly, even when the amount of light illuminating each of the sample tubes may change somewhat, the effect due to the change of the light amount can be eliminated by applying image processing so as to properly select a threshold value or conduct normalization and the progressing state of white turbidity and white sedimentation can be detected exactly.

From the foregoings, even when the amount of light changes under the effect of heat, the turbidity can be detected accurately by attaching the light emitting devices at the bottom of the arrangement holes integrally with the reaction block, and the alignment of the optical axes is not necessary in a case where the light emitting devices are attached integrally with the reaction block.

Further, since it may suffice for the image pick-up camera that it is situated at a position where all the sample tubes are with in the view field and, whether the position for installation is appropriate or not can be confirmed extremely easily by merely observing the images, accurate alignment for the optical axis of the camera is not necessary at all to simplify the assembling operation of the device.

In the same manner, in a case of using a not transparent substrate and intending to judge the presence or absence of the gene amplification by the LAMP method based on the fluorescence of the sample, a fluorescent material that interacts with a gene (nucleic acid) to be amplified to show a fluorescent reaction is mixed in the sample.

Since the interaction is not caused in a state where the gene amplification does not proceed, the sample does not show fluorescence even when the excitation light is irradiated and, accordingly it appears dark when photographed by the image pick-up camera.

Further, since the amplified gene (nucleic acid) and the fluorescent material interact with each other as the gene amplification proceeds, it emits fluorescence when the excitation light is irradiated and, accordingly, it appears bright when photographed by the image pick-up camera.

In this case, since all of the sample tubes can be photographed simultaneously by the image pick-up camera, it can be judged easily which sample emits fluorescence. Further, since the data of the luminance distribution or chromaticity distribution read from the image data are recognized as the three dimensional information as described above, even when the amount of light irradiating each of the sample tubes changes somewhat, the effect due to the change of the amount of light can be eliminated and the progress of the fluorescent reaction can be detected exactly.

Further, accurate alignment for the optical axis of the camera is no more necessary at all and the assembling operation of the apparatus can be simplified in the same manner as described above.

### BRIEF DESCRIPTION OF THE DRAWINGS

FIG. 1 is a basic constitutional view showing an optical inspection apparatus according to the present invention,

FIG. 2 is an entire constitutional view,

FIG. 3 is an explanatory view showing a detection area of image data, FIG. 4 is an explanatory view showing the change of images along with progress of reaction,

FIG. 5 is a graph showing the result of image processing,

FIG. 6 is a graph showing the result of image processing,

FIG. 7 shows a main portion showing another embodiment of an optical inspection apparatus, and

FIG. 8 is an explanatory view of an existent apparatus.

### BEST MODE FOR PRACTICING THE INVENTION

A best embodiment according to the present invention is to be described by way of appended drawings.

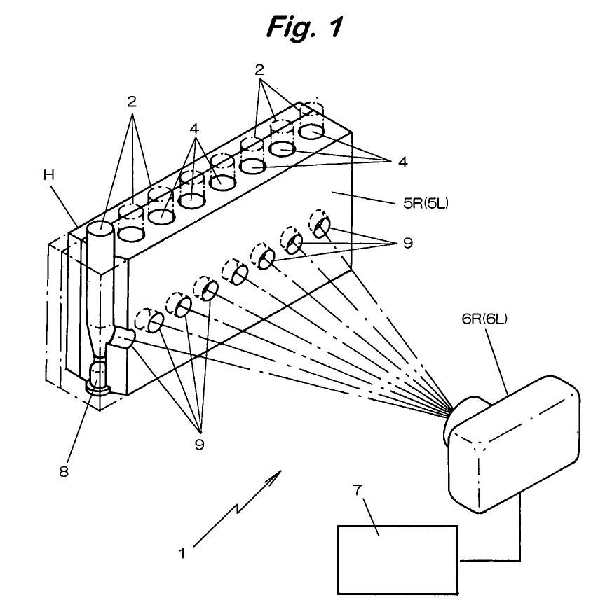

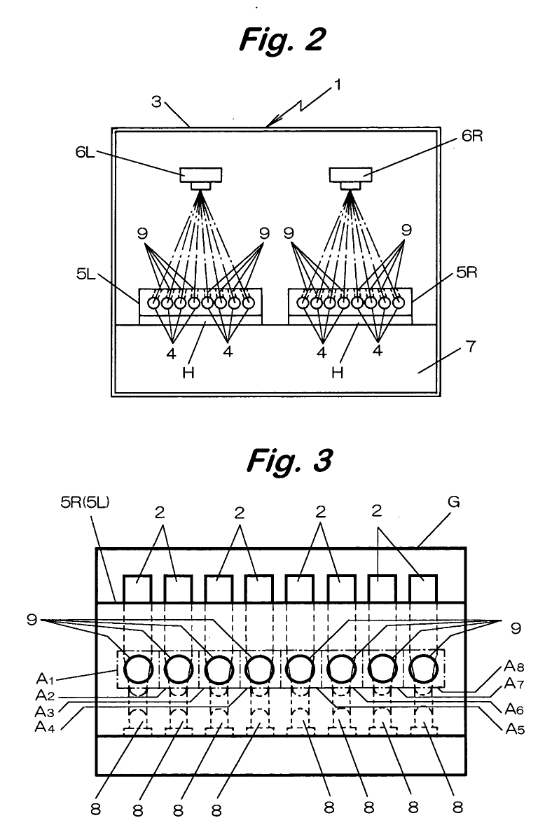

An optical inspection apparatus 1 shown in FIG. 1 is adopted to optically inspect samples in sample tubes 2,—for the presence or absence of a specified gene of pathogenic bacteria to be inspected (object to be inspected) by the turbidity thereof.

The optical inspection apparatus 1 includes, in housing 3, two reaction blocks 5R and 5L each having a plurality of arrangement holes 4,—in a lateral row for standing and arranging sample tubes 2,—two sets of image pick-up cameras 6R and 6L for photographing the sample tubes 2 on every reaction blocks 5R and 5L, and an operation processing device 7 for measuring the change of turbidity (optical change) caused in each of the sample tubes based on the luminance distribution or chromaticity distribution of the image data photographed by the image pick-up cameras 6R and 6L.

In each of the reaction blocks 5R and 5L, a heater H for maintaining the sample tubes 2 stood in the arrangement holes 4,—to a predetermined temperature is provided, and a light emitting devices (light emitting portion) 8 for irradiating a light to the respective sample tubes 2 stood in each of the arrangement holes 4 from below are fitted to the bottom of the arrangement holes 4.

For the light emitting portion, any member can be used not restricted to the light emitting device 8 such as LED, and light emitting ends of optical fibers may be provided. Further, observation holes 9 are perforated to the lateral surface of the reaction blocks 5R and 5L for photographing the respective sample tubes 2 on the radial lines directing from the lens of image pick-up cameras 6R and 6L to the respective sample tubes 2.

The observation hole 9 may be in any shape so long as it is formed not to interrupt the optical path directed from the image pick-up cameras 6R, 6L to the sample tube 2 and, for example, a horizontal slit may be formed to the lateral surface of the reaction blocks 5R and 5L.

The image data photographed by the image pick-up cameras 6R and 6L are inputted to the operation processing device 7 and turbidity is measured on every samples.

In the operation processing device 7, as shown in FIG. 3, detection areas A₁ to A₈ for photographing the sample tubes 2 through the respective observation holes 9 are set on the image data G, and the turbidity is measured individually based on the data for each of the detection areas A₁ to A₈.

In a case of conducting gene amplification by the LAMP method, when a gene is amplified along with progress of the reaction of the sample, magnesium pyrophosphate is produced and the white turbidity proceeds along with the amount of production.

FIG. 4(a) to (d) are explanatory views showing the change of images for four kinds of density: OD=0, 0.02, 0.2, and 0.4 for the sample formed with a turbid state by diffusing polystyrene particles in pure water.

The density is measured by using visible ultra violet spectrophotometer.

At density OD=0, as shown in FIG. 4(a), inside of the sample stagnating at the bottom of the sample tube 2 is uniformly dark and, accordingly, the image data observed from the observation hole 9 is also dark uniformly.

At density OD=0.02, white turbidity occurs slightly and, as shown in FIG. 4(b), since the light from the light emitting device 8 slightly scatters in the sample, scattering of light is observed slightly along the center line of the sample tube and the portion appears somewhat bright.

At density OD=0.2, white turbidity proceeds considerably and, as shown in FIG. 4(c), the light from the light emitting device 8 scatters in the sample and a high luminance portion observed along the center line of the sample tube 2 is also increased.

At density OD=0.4, the entire sample causes white turbidity and, as shown in FIG. 4(d), the high luminance portion at the central portion extends entirely.

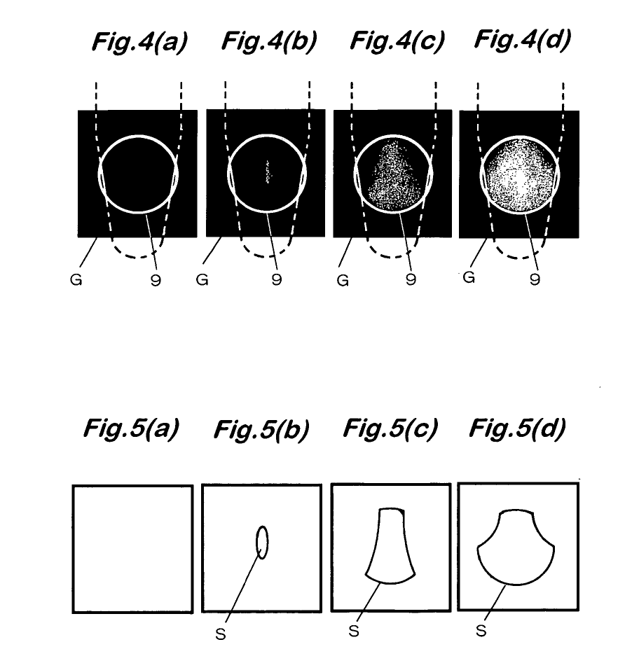

Thus, for example, by obtaining the luminance distribution data for each of the detection areas A₁ to A₈ by the image processing and extracting the shape of a luminance portion higher than the 50% luminance for the highest luminance in the each of the images as a threshold value, the shape changes as shown in FIG. 5(a) to (d).

Then, by defining the area S for the shape as the turbidity or arranging the relation between the turbidity measured by other method and the area S as data, the turbidity can be calculated based on the detected area S.

Accordingly, the turbidity is measured in accordance with the area S and a lamp may be lit or alarming sound may be rung for informing the completion of the reaction at the instance the turbidity reaches a predetermined value.

In this case, the turbidity is not measured by using the luminance as a direct parameter but the turbidity is measured based on the luminance distribution. According to this, it has been confirmed that the turbidity can be measured accurately even when the amount of light from the light emitting device 8 changes somewhat.

Further, even when clouding or bubbling is present in the sample tube 2, since this gives no significant effect on the entire luminance distribution, erroneous measurement caused thereby can be avoided.

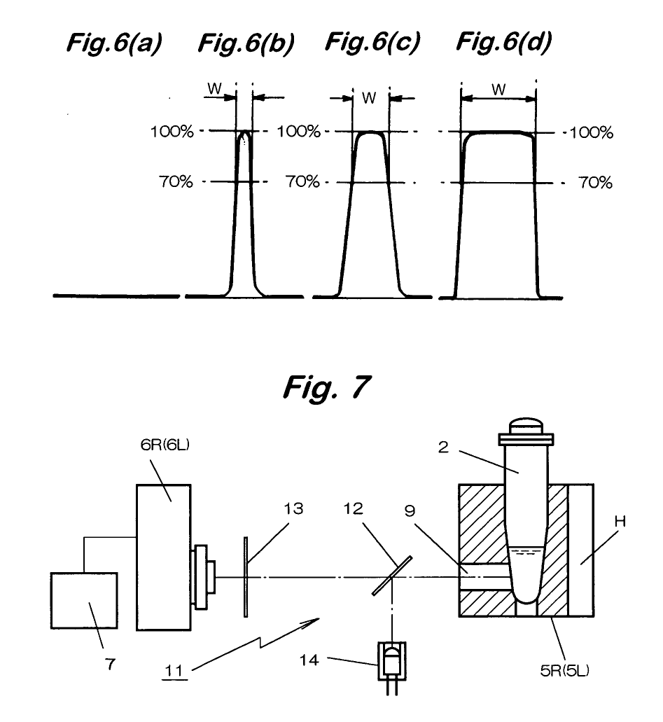

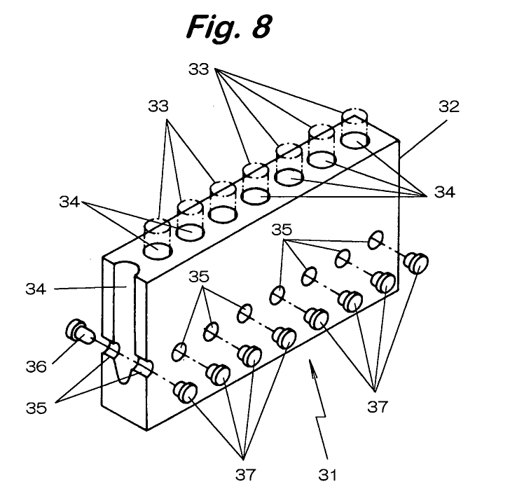

Further, by obtaining the luminance distribution in the horizontal direction by image processing and conducting normalization with respect to the highest luminance being as 100%, the graph is as shown in FIG. 6(a) to (d).

Then, when the width for a portion at a luminance higher than the threshold value of the normalized luminance 70% is set as a luminance 70% width W, which is defined as the turbidity, or the relation between the turbidity measured by other method and the luminance 70% width W is arranged into data, the turbidity can be calculated based on the detected luminance 70% width W.

Then, a lamp may be lit or bell may be rung for informing the completion of the reaction at the instance the thus measured turbidity reaches a predetermined value.

Also in this case, the turbidity is not measured by using the luminance as a direct parameter but the turbidity is measured based on the luminance distribution. According to this, it could be confirmed that the turbidity can be measured accurately even when the amount of light from the light emitting devices 8 changes somewhat.

Further, in a case where clouding or bubbling is present in the sample tube 2, this does not cause erroneous measurement in the same manner as described above.

While it has been described only to a case of measuring the turbidity based on the luminance distribution in the foregoing explanation, this is also applicable to a case of measuring the turbidity by the chromaticity distribution, for example, based on RGB signals instead of the luminance distribution.

That is, when white turbidity and white sedimentation occur, since the light from the light emitting device 8 is detected as a scattered light, the chromaticity for the portion corresponding to the high luminance portion becomes higher.

Accordingly, the turbidity can be measured based on the chromaticity distribution instead of the luminance distribution in the same manner as described above.

Further, presence or absence of a specified gene (object to be measured) can be detected by the fluorescence of a sample instead of the turbidity.

In this case, a fluorescent material showing fluorescent reaction is previously mixed with the sample in the sample tube 2.

In this example, ethidium bromide that interacts with an amplified DNA (nucleic acid) to enter the double strand thereof and emits orange fluorescence at 590 nm by irradiation of a ultra violet light at 300 nm as an excitation light is used as the fluorescent material.

In this case, when UV-emitting diode that output a UV light at 300 nm is fitted as the light emitting device 8 to the bottom of the arrangement hole 4, fluorescence is observed in accordance with the progress of the gene amplification in the sample tube 2, and it is photographed by image pick up cameras 6R and 6L. Then, when the intensity of fluorescence is measured based on the luminance distribution or the chromaticity distribution of the image data, presence or absence of an object to be inspected can be detected.

Further, FIG. 7 is a main portion showing another embodiment of an optical inspection apparatus 11 in a case of conducting fluorescence measurement. Those portions in commons with FIG. 1 carry same reference numerous, for which detailed description is omitted.

In this example, a half mirror 12 and a filter 13 are situated on an optical path from each of observation holes 9 to each image pick-up camera 6R, 6L, and a UV light at 300 nm irradiated from a UV-emitting diode (light emitting portion) 14 is reflected on the half mirror 12 and is irradiated as an excitation light passing through the observation hole 9,—to each sample tube 2.

For the filter 13, those having a high transmittance to an orange light at 590 nm and a low transmittance to a light at other wavelength is used, so that only the fluorescence caused in a sample tube can be observed while eliminative the effect of light other than the fluorescence.

In this case, while alignment of optical axis for irradiating the excitation light irradiated from the light emitting diode 14 to the sample 2 is necessary, alignment of optical axes for the image pick-up cameras 6R, 6L is not necessary.

As has been described above, the optical inspection apparatus 1, 11 of the invention provides an effect capable of judging the presence or absence of an object to be inspected by observing the optical change of turbidity and fluorescence caused in the sample based on the luminance distribution or the chromaticity distribution of image data for the sample tube 2 photographed by way of the observation holes 9.

In this case, since the optical change is observed based on the luminance distribution or the chromaticity distribution, it provides an excellent advantage capable of eliminating the effect due to the change of the optical amount even when the amount of inspection light for irradiating the sample tube 2 changes somewhat by properly selecting the threshold value or conducting normalization by applying image processing.

Further, even when clouding or bubbling is present in the sample tube 2, this gives no significant effect on the entire luminance distribution and it provides an excellent advantage capable of accurately detecting the optical change of turbidity or fluorescence.

Further, since it may suffice that the image pick-up cameras 6R, 6L are installed at the position where the sample tubes 2 to be observed are at positions within the view field, and it can be easily confirmed whether the installation position is appropriate or not by merely viewing the images, it can provide an excellent advantage of requiring no troublesome alignment for optical axes at all and capable of simplifying the assembling operation of the apparatus.

### INDUSTRIAL APPLICABILITY

As described above, the optical inspection apparatus according to the present invention can be used in applications such as in the fields of biochemistry, medicine and pharmacy, foodstuffs, etc. for inspecting whether particular pathogenic germs, bacteria, microorganisms or chemical substances as the object to be inspected are present or not in the sample as the test specimen simply, rapidly, accurately and inexpensively and it can be used particularly for the application of inspecting the presence or absence of a specified gene by the amplification thereof as in the LAMP method.

1. An optical inspection apparatus for inspecting the presence or absence of an object to be inspected that causes optical changes such as white turbidity and white sedimentation, or fluorescence for a sample charged in a sample tube, including
a reaction block in which a plurality of arrangement holes for standing and arranging sample tubes are formed, a light emitting portion for irradiating an inspection light to the respective sample tubes through observation holes formed to the lateral surface or holes formed in the bottom of the reaction block, an image pick-up camera for photographing each of the sample tubes passing through the observation holes, and
an operation processing device for measuring the optical change caused in the sample tubes based on the luminance distribution or the chromaticity distribution of image data photographed by the image pick-up camera.

2. An optical inspection apparatus according to claim 1, wherein an inspection light is irradiated from the light emitting portion through the holes formed in the bottom of the reaction block to the respective sample tubes, and the white turbidity and white sedimentation caused in the sample are measured as the optical change based on the luminance distribution or the chromaticity distribution obtained in the image data.

3. An optical inspection apparatus according to claim 1, wherein an excitation light at a wavelength corresponding to a fluorescent material mixed previously with the sample is irradiated as an inspection light and the fluorescence caused in the sample is measured as an optical change based on the luminance distribution or the chromaticity distribution obtained in the image data.

4. An optical inspection apparatus according to claim 1, wherein the observation holes are formed on radial lines from the lens of the image pick-up camera to the respective sample tubes.

5. An optical inspection apparatus according to claim 1, wherein the light emitting devices are disposed at the bottom to the respective arranged holes.
